(19) United States
(12) Patent Application Publication
(10) Pub. No.: US 2025/0074246 A1
(43) Pub. Date: Mar. 6, 2025

(54) CHARGING ALLOCATION DEVICES, METHODS, AND SYSTEMS OF CHARGING STATIONS

(71) Applicant: XCHARGE ENERGY USA INC., San Marcos, TX (US)

(72) Inventors: Rui DING, San Marcos, TX (US); Junshuai WANG, San Marcos, TX (US)

(73) Assignee: XCHARGE ENERGY USA INC., San Marcos, TX (US)

(21) Appl. No.: 18/464,254

(22) Filed: Sep. 10, 2023

Related U.S. Application Data
(63) Continuation of application No. PCT/US23/73120, filed on Aug. 29, 2023.

(51) Int. Cl. B60L 53/63; B60L 53/62; B60L 53/67; B60L 53/68

(52) U.S. Cl. CPC B60L 53/63; B60L 53/62; B60L 53/67; B60L 53/68; B60L 2240/70

(57) ABSTRACT

The embodiments of the present disclosure provide a charging allocation device, method, and system of a charging station. The method is implemented based on the charging allocation device of the charging station. The charging allocation device of the charging station includes a first sensor, a second sensor, a third sensor, a charging module, and a processor. The method is executed by the processor. The method includes: determining an electrical storage feature based on first sensing information; determining an electrical supply feature based on second sensing information; determining a vehicle demand feature based on third sensing information; determining a charging allocation strategy of the charging station during a preset future time period based on the electrical storage feature, the electrical supply feature, the vehicle demand feature, and a charging target; and controlling, based on the charging allocation strategy, at least one of an electrical grid or a battery to charge, through the charging module, a target object according to at least one charging power within the preset future time period.

### CROSS-REFERENCE TO RELATED APPLICATIONS

This application is a continuation of International Application No. PCT/US23/73120, filed on Aug. 29, 2023, the entire contents of which are hereby incorporated by reference.

### TECHNICAL FIELD

The present disclosure relates to a field of charging and exchanging technology of electric vehicles, and in particular to charging allocation devices, methods, and systems of charging stations.

### BACKGROUND

With the development of new energy technology, new energy vehicles are gradually entering the travel market. New energy vehicles need to be charged and used, and a charging process is usually achieved by using charging stations configured in electrical grid. Due to the popularity of the new energy vehicles, one charging station needs to charge multiple new energy vehicles, thereby increasing the load of the electrical grid. Moreover, when charging during a peak period of electricity consumption, a relatively high electricity price increases the travel cost of users. At this time, a user utilization rate of the charging station is relatively low, so the charging station is prone to generate too much surplus electricity during the peak period, resulting in energy waste.

Therefore, it is desirable to provide charging allocation devices, methods, and systems of the charging station that can provide the users with an optimal charging allocation strategy to improve the quality of charging services for new energy vehicles, reduce energy waste, and improve the user experience.

### SUMMARY

According to one or more embodiments of the present disclosure, a charging allocation device for a charging station is provided. The charging allocation device of the charging station includes a first sensor, a second sensor, a third sensor, a charging module, and a processor. The processor is in communication with the first sensor, the second sensor, the third sensor, and the charging module. The processor is configured to determine an electrical storage feature based on first sensing information, wherein the first sensing information is collected by the first sensor based on a battery of the charging station, and the electrical storage feature at least includes a storage capacity of the battery. The processor is further configured to determine an electrical supply feature based on second sensing information, wherein the second sensing information is collected by the second sensor based on an electrical grid, and the electrical supply feature at least includes an electrical supply cost of the electrical grid. The processor is further configured to determine a vehicle demand feature based on third sensing information, wherein the third sensing information is collected by the third sensor based on a charging vehicle, and the vehicle demand feature at least includes a charging demand power of the charging vehicle. The processor is further configured to determine a charging allocation strategy of the charging station during a preset future time period based on the electrical storage feature, the electrical supply feature, the vehicle demand feature, and a charging target. The processor controls, based on the charging allocation strategy, at least one of the electrical grid or the battery to charge, through the charging module, a target object according to at least one charging power within the preset future time period.

According to one or more embodiments of the present disclosure, a method for charging allocation of a charging station is provided. The method includes: determining an electrical storage feature based on first sensing information, wherein the first sensing information is collected by a first sensor based on a battery of the charging station, and the electrical storage feature at least includes a storage capacity of the battery. The method further includes determining an electrical supply feature based on second sensing information, wherein the second sensing information is collected by a second sensor based on an electrical grid, and the electrical supply feature at least includes an electrical supply cost of the electrical grid. The method further includes determining a vehicle demand feature based on third sensing information, wherein the third sensing information is collected by a third sensor based on a charging vehicle, and the vehicle demand feature at least includes a charging demand power of the charging vehicle. The method further includes determining a charging allocation strategy of the charging station during a preset future time period based on the electrical storage feature, the electrical supply feature, the vehicle demand feature, and a charging target. The method further includes controlling, based on the charging allocation strategy, at least one of the electrical grid or the battery to charge, through a charging module, a target object according to at least one charging power within the preset future time period.

According to one or more embodiments of the present disclosure, a system for charging allocation of a charging station is provided. The system includes a first obtaining module configured to determine an electrical storage feature based on first sensing information, wherein the first sensing information is collected by a first sensor based on a battery of the charging station, and the electrical storage feature at least includes a storage capacity of the battery. The system further includes a second obtaining module configured to determine an electrical supply feature based on second sensing information, wherein the second sensing information is collected by a second sensor based on an electrical grid, and the electrical supply feature at least includes an electrical supply cost of the electrical grid. The system further includes a third obtaining module configured to determine a vehicle demand feature based on third sensing information, wherein the third sensing information is collected by a third sensor based on a charging vehicle, and the vehicle demand feature at least includes a charging demand power of the charging vehicle. The system further includes a determination module configured to determine a charging allocation strategy of the charging station during a preset future time period based on the electrical storage feature, the electrical supply feature, the vehicle demand feature, and a charging target. The system further includes a control module configured to control, based on the charging allocation strategy, at least one of the electrical grid or the battery to charge, through a charging module, a target object according to at least one charging power within the preset future time period.

According to one or more embodiments of the present disclosure, a non-transitory computer-readable storage medium is provided. The non-transitory computer-readable storage medium includes a set of instructions, wherein when executed by a computing device, the set of instructions causes the computing device to perform a method for charging allocation of a charging station.

### BRIEF DESCRIPTION OF THE DRAWINGS

The present disclosure will be further illustrated by way of exemplary embodiments, which will be described in detail by way of the accompanying drawings. These embodiments are not limiting, and in these embodiments, the same counting indicates the same structure, wherein:

FIG. 1 is a schematic diagram illustrating an exemplary system for charging allocation of a charging station according to some embodiments of the present disclosure;

FIG. 2 is a schematic diagram illustrating a device for charging allocation of a charging station according to some embodiments of the present disclosure;

FIG. 3 is a flowchart illustrating an exemplary method for charging allocation of a charging station according to some embodiments of the present disclosure;

FIG. 4 is a flowchart illustrating an exemplary method for charging allocation of a charging station based on a second target according to some embodiments of the present disclosure; and

FIG. 5 is a flowchart illustrating an exemplary method for charging allocation of a charging station based on a third target according to some embodiments of the present disclosure.

### DETAILED DESCRIPTION

To more clearly illustrate the technical solutions of the embodiments of the present disclosure, the accompanying drawings that need to be used in the description of the embodiments would be briefly introduced below. Obviously, the accompanying drawing in the following description is merely some examples or embodiments of the present disclosure, and those skilled in the art can apply the present disclosure to other similar situations according to the drawings without any creative effort. Unless obviously obtained from the context or the context illustrates otherwise, the same numeral in the drawings indicates the same structure or operation

It will be understood that the terms “system,” “device,” “unit,” and/or “module” used herein are used to distinguish different components, elements, parts, sections, or assemblies of different levels. However, the terms may be displaced by other expressions if they may achieve the same purpose.

As used in the present disclosure and the appended claims, the singular forms “a,” “an,” and “the” are intended to include plural referents, unless the content clearly dictates otherwise. Generally, the terms “comprise” and “include” only imply that the clearly identified steps and elements are included, but these steps and elements do not constitute an exclusive list, and the method or device may further include other steps or elements.

The flowcharts used in the present disclosure illustrate operations that systems implement according to some embodiments in the present disclosure. It is to be expressly understood, the operations of the flowchart may be implemented not in order. Conversely, the operations may be implemented in an inverted order, or simultaneously. Moreover, one or more other operations may be added to the flowcharts. One or more operations may be removed from the flowcharts.

One or more embodiments of the present disclosure relate to a method for charging allocation of a charging station. The method may include determining a charging allocation strategy for the charging station during a preset future time period based on an electrical storage feature, an electrical supply feature, a vehicle demand feature, and a charging target. A processor may control, based on the charging allocation strategy, at least one of an electrical grid or a battery to charge, through a charging module, a target object according to at least one charging power during the preset future time period.

Some embodiments of the present disclosure may be applied to charge a charging vehicle through the electrical grid or the battery of the charging station when photovoltaic power generation is not available. Exemplarily, when there is no charging vehicle, the battery of the charging station may be charged through the electrical grid to ensure a storage capacity of the battery. Some embodiments of the present disclosure may balance the charging allocation strategy of the battery of the charging station and the electrical grid at different times of the day based on a charging demand power of the charging vehicle. Different charging allocation strategies may determine battery operating state and power allocation of the charging station based on, for example, grid tariffs, the storage capacity of the battery, the charging demand power, etc., thereby reducing energy waste and improving the user experience.

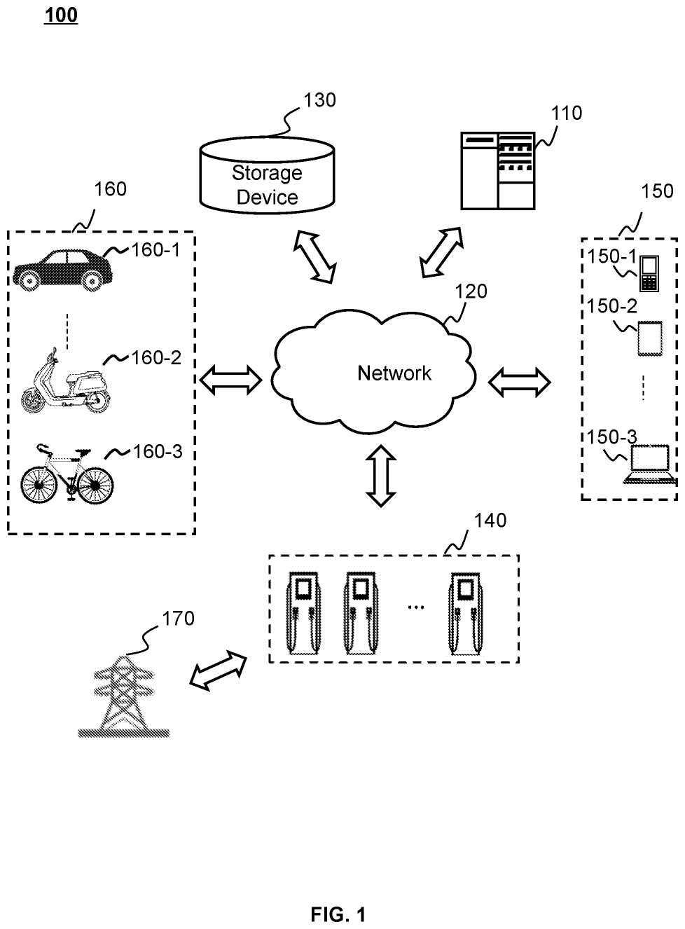

FIG. 1 is a schematic diagram illustrating an exemplary system for charging allocation of a charging station according to some embodiments of the present disclosure. As shown in FIG. 1, a system 100 may include a processing device 110, a network 120, a storage device 130, a charging station 140, a terminal 150, a charging vehicle 160, and an electrical grid 170.

In some embodiments, components in the system 100 may be connected and/or communicated with each other through the network 120. For example, the processing device 110 may be connected to the storage device 130 through the network 120.

In some embodiments, the processing device 110 may process information and/or data related to the system 100 of the charging allocation device of the charging station to perform one or more functions described in the present disclosure. For example, the processing device 110 may determine a vehicle demand feature based on sensing information of a new energy vehicle. In some embodiments, the processing device 110 may include one or more processing engines. The processing device 110 may process data, information, and/or processing results obtained from other devices or system components, and execute program instructions based on the data, the information, and/or the processing results to perform the one or more functions described in the present disclosure.

The network 120 may provide any suitable network capable of facilitating an exchange of information and/or data for charging allocation of the charging station. The information and/or data may be exchanged between one or more components of the charging allocation device of the charging station through the network 120. For example, the network 120 may feed a charging allocation strategy back to the charging station through an energy management system.

The storage device 130 may be configured to store data, instructions, and/or any other information. In some embodiments, the storage device 130 may store the data and/or the information obtained from the processing device 110, the terminal 150, etc. For example, the storage device 130 may store an electrical storage feature, an electrical supply feature, a vehicle demand feature, etc. In some embodiments, the storage device 130 may be provided in the processing device 110.

The charging station 140 refers to any charging station that can provide charging services for users' vehicles. For example, the charging station 140 may include a plurality of charging stations located in different areas.

The terminal 150 is a terminal device used by a user. In some embodiments, the terminal 150 may include a mobile device 150-1, a tablet 150-2, a laptop 150-3, etc., or any combination thereof. The mobile device 150-1 may interact with other components of the charging allocation device of the charging station through the network 120.

The charging vehicle 160 is a vehicle that needs to be charged. In some embodiments, the charging vehicle 160 may include an electric vehicle 160-1, an electric motorcycle 160-2, an electric bicycle 160-3, etc., or any combination thereof. The charging vehicle 160 may interact with other components in the charging allocation device of the charging station through the network 120.

The electrical grid 170 can supplement the charging station 140 with electrical energy. In some embodiments, the charging station 140 may be directly connected to the electrical grid 170.

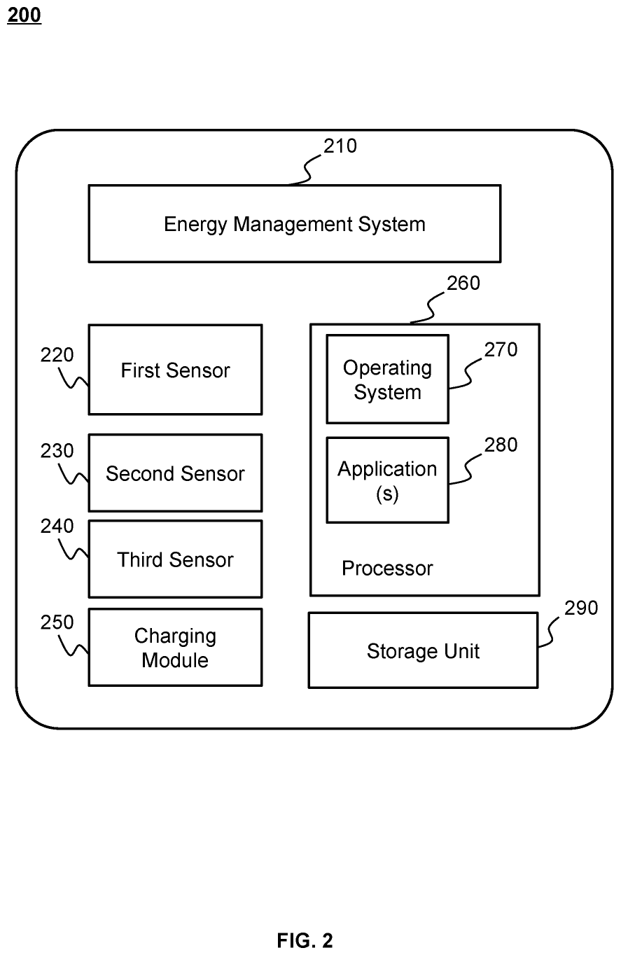

FIG. 2 is a schematic diagram illustrating a device for charging allocation of a charging station according to some embodiments of the present disclosure. As shown in FIG. 2, a charging allocation device 200 of the charging station includes an energy management system 210, a first sensor 220, a second sensor 230, a third sensor 240, a charging module 250, a processor 260, an operating system 270, an application 280, and a storage unit 290.

In some embodiments, the energy management system 210 may be provided with a management master platform database and a plurality of management sub-platforms (including management sub-platform database thereof). The plurality of management sub-platforms store and process different types of data sent by the first sensor 220, the second sensor 230, the third sensor 240, etc., respectively. The management master platform database stores and processes the data from the plurality of management sub-platforms after aggregation, and transmits the data to the storage unit 290.

In some embodiments, the energy management system 210 may interact with the charging module 250. For example, the energy management system 210 receives information related to the charging station 140 uploaded and processed by a sensor, and sends instructions related to a charging allocation strategy to the charging module 250.

In some embodiments, the energy management system 210 may be configured to obtain user demand information through the processor 260. For example, the energy management system 210 may receive and process information related to a query (e.g., a charging price) entered by the user in the charging allocation device 200 of the charging station, provide the information to other modules or units of the system 100 (e.g., the network 120), and provide feedback, such as recommendation information, etc., back to the user.

In some embodiments, the sensor may include a first sensor 220, a second sensor 230, and a third sensor 240. Different sensors may be configured to collect feature information of different objects. For example, the first sensor 220 may be configured to collect feature information related to the charging station, the second sensor 230 may be configured to collect feature information related to the electrical grid, and the third sensor 240 may be configured to collect feature information related to a charging vehicle.

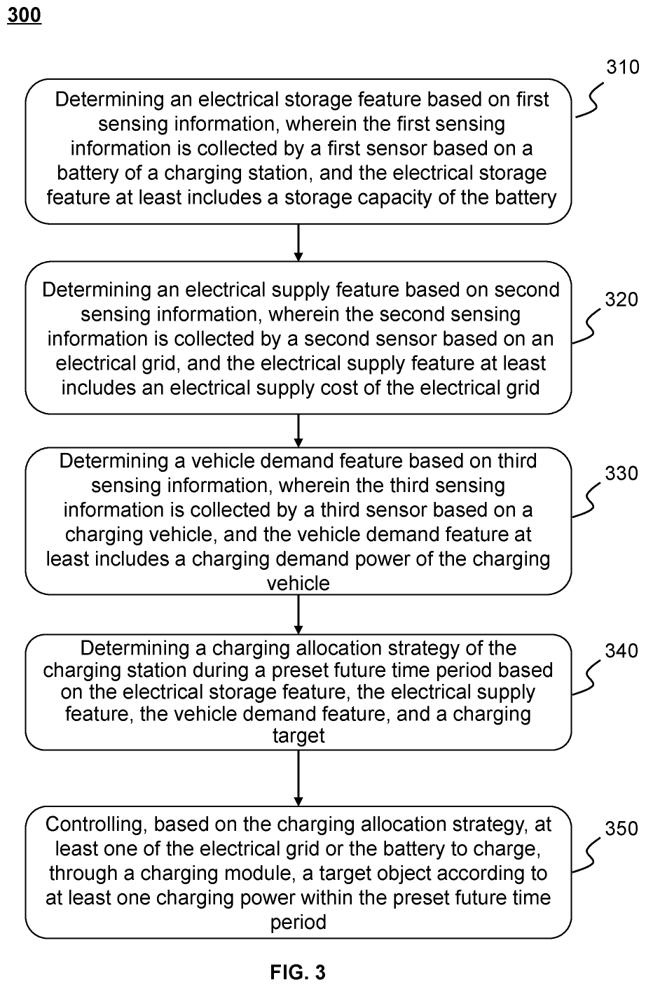

In some embodiments, the sensor may be a separate device provided separately from the charging allocation device 200 of the charging station or may be a part of the charging allocation device 200 of the charging station. More descriptions regarding the sensor may be found in FIG. 3 and its related descriptions.

In some embodiments, the charging module 250 may be configured to store electricity and/or supply power to the charging vehicle 160. The charging module 250 at least includes an alternating current direct current (ACDC) module, a direct current direct current (DCDC) module, and a photovoltaic module. For example, the ACDC module may be used in the electrical grid to supplement power to the charging station 140, the DCDC module may be used in the charging station 140 to supply power to the charging vehicle 160, and the photovoltaic module may be configured to convert a low voltage direct current generated based on solar energy into an alternating current and supply power to the charging vehicle 160.

In some embodiments, the charging allocation device 200 of the charging station may also include a processor 260 configured to execute program instructions. For example, methods and/or processes of the present disclosure may be loaded to and executed by the processor 260 in a form of program instruction.

In some embodiments, as shown in FIG. 2, the operating system 270 (e.g., IOS, Android, etc.) and one or more applications 280 may be loaded from the storage unit 290 to the processor 260, such that the process 260 executes related program instructions.

In some embodiments, the charging allocation device 200 of the charging station may also include, but is not limited to, any other suitable components of an off-grid inverter, a grid-connected inverter, or a controller (not shown in FIG. 2), which is not limited herein.

FIG. 3 is an exemplary flowchart illustrating a method for charging allocation of a charging station according to some embodiments of the present disclosure. As shown in FIG. 3, process 300 includes operations 310-350. In some embodiments, one or more operations of the process 300 shown in FIG. 3 may be implemented in the charging allocation device 200 of the charging station shown in FIG. 2. In some embodiments, the process 300 may be performed by the processor 260.

In 310, an electrical storage feature is determined based on first sensing information.

The first sensing information refers to sensing information associated with a charging station. For example, the first sensing information may include one or more of battery reference information, state information, location information, or the like, of the charging station. The battery reference information may include an output power, an electrical storage feature, etc. The state information may refer to an operating state of the charging station. For example, the state information may include a charging state, an idle state, or the like. The location information may be information related to the current location of the charging station. For example, the charging station is located at a highway entrance, a highway exit, a highway section, etc.

The electrical storage feature refers to a feature related to an electric capacity of the battery of the charging station. In some embodiments, the electrical storage feature at least includes the storage capacity of the battery. The storage capacity of the battery may refer to the remaining capacity of the battery. The storage capacity may be expressed as a number, a percentage, etc. For example, the storage capacity of the battery may be 35 kWh. As another example, the storage capacity of the battery may be 80% of a total capacity.

In some embodiments, the processor 260 may determine the electrical storage feature through a plurality of approaches based on the first sensing information. For example, the processor 260 may determine the electrical storage feature by looking up a preset table. The preset table may include an association relationship between the battery reference information of the charging station and the electrical storage feature in the first sensing information. The processor 260 may determine the electrical storage feature based on the battery reference information of the charging station and the association relationship.

In some embodiments, a first sensor may collect the first sensing information based on the battery of the charging station. For example, the first sensor may start or stop collecting the first sensing information based on a set time, or may collect the first sensing information based on a set time interval.

In 320, an electrical supply feature is determined based on second sensing information.

The second sensing information refers to sensing information related to an electrical grid. For example, the second sensing information may include one or more of load information of the electrical grid, state information of the electrical grid, etc. The load information of the electrical grid may include charging station load information and regular customer electricity consumption load information. The state information of the electrical grid may include a peak period, flat period, a valley period, etc. As used herein, the peak period refers to a time period when the electricity consumption is in a first electricity consumption stage, the flat period refers to a time period when the electricity consumption is in a second electricity consumption stage, and the valley period refers to a time period when the electricity consumption is in a third electricity consumption stage. The electricity consumption stage refers to a range of the total electricity consumption per unit time. The ranges of the total electricity consumption per unit time corresponding to the first electricity consumption stage, the second electricity consumption stage, and the third electricity consumption stage decrease in order. The first electricity consumption stage represents a peak value of electricity consumption, the third electricity consumption stage represents a valley value of electricity consumption. The first electricity consumption stage, the second electricity consumption stage, and the third electricity consumption stage are determined at least based on location of the charging station and season when using the charging station. For example, the first electricity consumption stage, the second electricity consumption stage, and the third electricity consumption stage may be determined based on historical electricity consumption data in the same location and season.

In some embodiments, the state information of the electrical grid may be related to electricity price information. For example, an electricity price corresponding to the peak period is higher than a first electricity price threshold, an electricity price corresponding to the valley period is lower than a second electricity price threshold, and an electricity price corresponding to the flat period is between the first electricity price threshold and the second electricity price threshold. The second electricity price threshold is less than the first electricity price threshold.

In some embodiments, the first electricity price threshold and the second electricity price threshold may be at least one of a system setting value, or an empirical value.

In some embodiments, a second sensor may collect the second sensing information based on the electrical grid. For example, the second sensor may start or stop collecting the second sensing information based on a set time, or may collect the second sensing information based on a set time interval.

The electrical supply feature refers to a feature associated with the electrical supply of the electrical grid. In some embodiments, the electrical supply feature at least includes an electrical supply cost of the electrical grid. The electrical supply cost of the electrical grid at least includes electricity price information. For example, an average electricity price during the peak period is $1.2368/kWh, an average electricity price during the flat period is $0.8083/kWh, and an average electricity price during the valley period is $0.4018/kWh.

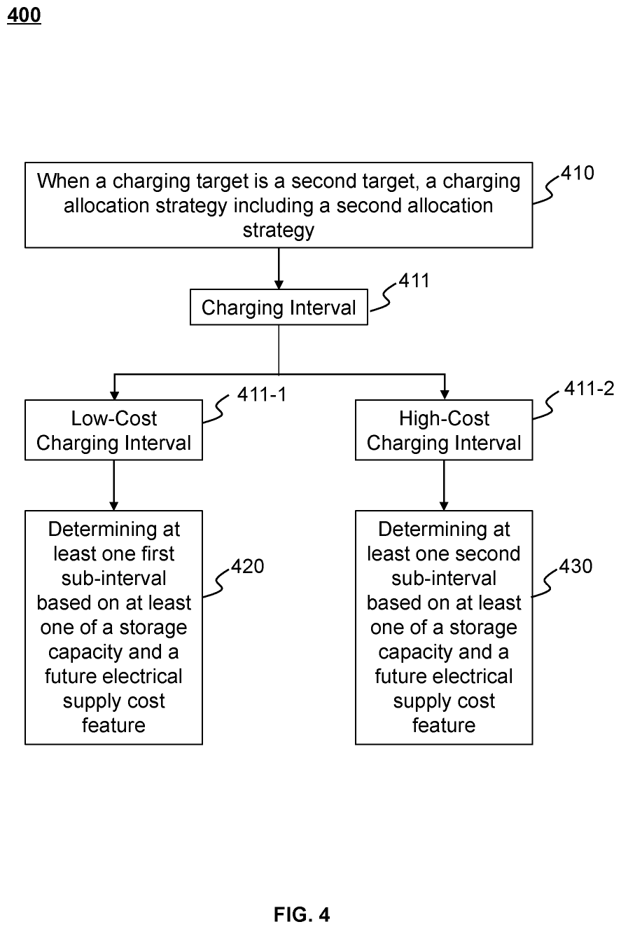

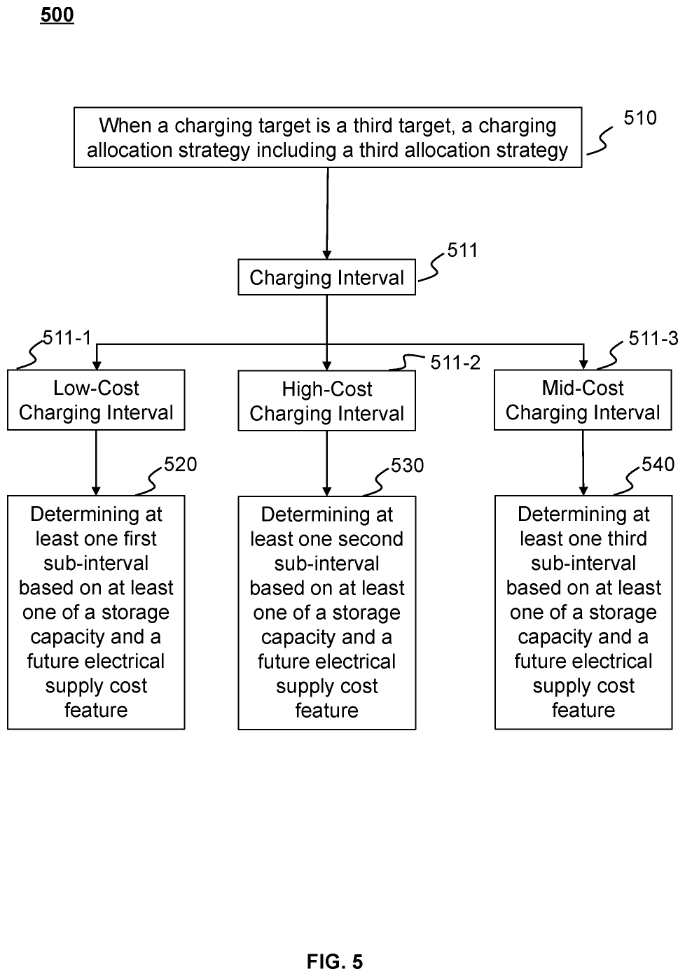

In some embodiments, the electrical supply feature may also include a future electrical supply cost feature. More descriptions regarding the future electrical supply cost feature may be found in FIG. 4 and FIG. 5 and their related descriptions.

In some embodiments, the processor 260 may determine the electrical supply feature through a plurality of approaches based on the second sensing information. For example, the processor 260 may determine the electrical supply feature by looking up a preset table. The preset table may include an association relationship between the state information of the electrical grid in the second sensing information and the electrical supply feature. The processor 260 may determine the electrical supply feature based on the state of the electrical grid and the association relationship. Exemplarily, the processor 260 may determine the electricity price information corresponding to a respective electrical supply time period (e.g., the peak period, the flat period, the valley period) based on the state information of the electrical grid and the association relationship.

In some embodiments, the energy management system 210 may also obtain the electrical supply feature by reading real-time data from an electrical grid system.

In 330, a vehicle demand feature is determined based on third sensing information.

The third sensing information refers to sensing information related to a charging vehicle. For example, the third sensing information may include one or more of a remaining capacity of the charging vehicle, a positioning location of the charging vehicle, etc. The remaining capacity of the charging vehicle may be displayed on a dashboard or a display of the vehicle. The positioning position of the charging vehicle may be obtained by a positioning device such as a loaded GPS, a user terminal, etc.

In some embodiments, a third sensor may collect the third sensing information based on the charging vehicle. For example, the third sensor may start or stop the collection of the third sensing information based on a set time, or may collect the third sensing information based on a set time interval.

The vehicle demand feature refers to a feature associated with a demand of the charging vehicle. In some embodiments, the vehicle demand feature at least includes a charging demand power of the charging vehicle, a charging demand capacity of the charging vehicle, etc.

In some embodiments, the processor 260 may determine the vehicle demand feature through a plurality of approaches based on the third sensing information. For example, the processor 260 may determine the vehicle demand feature by looking up a preset table. The preset table may further include an association relationship between the remaining capacity of the charging vehicle of the third sensing information and the vehicle demand feature. The processor 260 may determine the vehicle demand feature based on the remaining capacity of the charging vehicle and the association relationship.

In some embodiments, the energy management system 210 may also obtain the vehicle demand feature from the charging vehicle through a plurality of approaches. For example, the charging vehicle may actively send the charging demand power and/or the charging demand capacity to the energy management system 210.

In 340, a charging allocation strategy during a preset future time period is determined based on the electrical storage feature, the electrical supply feature, the vehicle demand feature, and a charging target.

In some embodiments, the charging target may include at least one of a first target, a second target, and a third target.

In some embodiments, the first target may include a requirement that prioritizing the charging demand power of the charging vehicle. In some embodiments, the first target may realize charging and power supplement at any time. For example, when the charging vehicle is connected to the charging station, the charging station may charge the charging vehicle at a maximum output power. Exemplarily, if the charging station is a DC charging station, the charging station may charge the charging vehicle at the maximum output power of 40 kW. As another example, when the operating state of the charging station is in an idle state, the electrical grid may charge the battery of the charging station at a certain output power. Exemplarily, a charging power of the electrical grid to charge the battery of the charging station may be 20 kW.

In some embodiments, the second target may include a requirement that prioritizing a charging cost. In some embodiments, the second target may achieve a two-stage charging. The two-stage charging may include two charging intervals. A charging interval may refer to a time period when the charging vehicle can be charged. In some embodiments, the charging interval may be determined based on the state information of the electrical grid. For example, when the electrical grid is at the valley period, the corresponding charging interval may be a low-cost charging interval. At this time, the processor 260 may control the electrical grid to charge at least one of the battery of the charging station and the charging vehicle. As another example, when the electrical grid is at the peak period, the corresponding charging interval may be a high-cost charging interval. At this time, the processor 260 gives priority to controlling the battery of the charging station to charge the charging vehicle. The processor 260 may control the electrical grid to charge the charging vehicle when the storage capacity of the battery is unable to satisfy the charging demand power and/or the charging demand capacity. More descriptions regarding the second target may be found in FIG. 4 and its related descriptions.

In some embodiments, the third target may include a requirement that balances the charging demand power and the charging cost. In some embodiments, the third target may achieve multi-stage charging. The multi-stage charging may include at least three charging intervals. For example, when the electrical grid is at the peak period, its corresponding charging interval may be a high-cost charging interval. The processor 260 may give priority to controlling the battery of the charging station to charge the charging vehicle. When the storage capacity of the battery does not meet the charging demand power and/or the charging demand capacity, the processor 260 may control the electrical grid to properly charge the battery of the charging station to meet the charging demand power and/or the charging demand capacity. At this point, only when the storage capacity of the battery is depleted, the processor 260 controls the electrical grid to charge the charging vehicle. More descriptions regarding the third target may be found in FIG. 5 and its related descriptions.

The preset future time period refers to a preset time period after the current moment. In some embodiments, the preset future time period may be preset by the energy management system 210. For example, the preset future time period may be 3 hours after the current moment. In some embodiments, the energy management system 210 may adjust the preset future time period based on a vehicle demand and/or the charging cost.

In some embodiments, the preset future time period may be determined based on an estimated charging duration. For example, if the processor 260 estimates a charging duration of 4 hours based on a count of charging vehicles, the preset future time period may be determined as 4 hours. More descriptions regarding the count of charging vehicles may be found in operation 340 and its related descriptions.

The charging allocation strategy refers to a power allocation strategy for charging the charging station. In some embodiments, the processor 260 may determine the charging allocation strategy based on the state information of the electrical grid and/or the electrical storage feature of the charging station. For example, when the electrical grid is at the peak period and the capacity of the battery of the charging station is relatively abundant, the battery of the charging station may be used first to charge the charging vehicle.

In some embodiments, the processor 260 may determine the charging target through a plurality of approaches based on evaluation parameters of candidate charging targets. The evaluation parameters may include one or more indicators (e.g., a target completion degree, an estimated total cost, etc.) for assessing whether the candidate charging targets meet and/or satisfy a certain condition. For example, the processor 260 may determine the charging target based on statistical values of the one or more indicators. Exemplarily, the processor 260 may first determine a mean value or a weighted average value of the one or more indicators, then rank the candidate charging targets based on the mean value or the weighted average value of the one or more indicators, and identify the candidate charging target with the largest mean value or weighted average value as the final charging target. As another example, the processor 260 may determine the charging target by constructing an evaluation vector based on the one or more indicators of the candidate charging targets. Exemplarily, the processor 260 may construct a historical evaluation vector based on one or more historical indicators, calculate a distance between the historical evaluation vector and the evaluation vector corresponding to each candidate charging target, and identify the candidate charging target with the smallest distance as the final charging target.

In some embodiments, the evaluation parameters may include the target completion degree and the estimated total cost. The processor 260 may determine a predicted charging demand power during the preset future time period, evaluate the target completion degree and the estimated total cost corresponding to each candidate charging target based on a predicted charging demand power, and determine the charging target based on the target completion degree and the estimated total cost.

The predicted charging demand power refers to a predicted value of the charging demand power. For example, if the charging station is an AC charging station, a predicted charging demand power may be 7 kW, and if the charging station is a DC charging station, a predicted charging demand power may be 30 kW, 60 kW, 100 kW, etc.

In some embodiments, the processor 260 may determine the predicted charging demand power during the preset future time period through a plurality of approaches. For example, the processor 260 may determine the predicted charging demand power during the preset future time period based on a historical charging demand power (e.g., 100 W, 150 W, etc.). Exemplarily, the processor 260 may determine the predicted charging demand power between the current moment and at least one preset future moment based on a preset conversion relationship by obtaining the historical charging demand power between the current moment and at least one historical moment. The preset conversion relationship refers to a preset relationship between the historical charging demand power and the charging demand power at the preset future moment.

In some embodiments, the processor 260 may determine the predicted charging demand power through a predictive model based on historical charging demand powers of vehicles at a plurality of historical time points, historical vehicle queuing information of the vehicles at the plurality of historical time points, and location information of the current charging station.

In some embodiments, the prediction model may be a machine learning model. For example, the prediction model may be a neural network (NN) model. As another example, the prediction model may also be any model for prediction such as a recurrent neural network (RNN) or any combination thereof.

In some embodiments, an input of the predictive model may include the historical charging demand powers of vehicles at a plurality of historical time points, the historical vehicle queuing information of the vehicles at the plurality of historical time points, and the location information of the current charging station. In some embodiments, the vehicle queuing information may include the count of charging vehicles, feature information of the charging vehicles, etc., or any combination thereof. The count of charging vehicles may refer to a sum of vehicles being charged and vehicles being in queue to be charged. The feature information of the charging vehicles may include a vehicle type, a vehicle model, a vehicle identification number, a license plate number, etc., of each charging vehicle. More descriptions regarding the charging demand power and the location information of the charging station may be found in operations 310 and 330 and their related descriptions.

In some embodiments, the count of charging vehicles may be determined by an image recognition algorithm based on the feature information of the charging vehicles. For example, the count of charging vehicles may be determined based on the image recognition algorithm by identifying license plate numbers. The image recognition algorithm may include a depth-first search algorithm, a Dijkstra algorithm, a Kruskal algorithm, or the like.

In some embodiments, an output of the predictive model may include the predicted charging demand power of at least one preset future time point.

In some embodiments, the prediction model may be trained through a plurality of training samples with labels. In some embodiments, the training samples may at least include historical charging demand powers of vehicles, historical vehicle queuing information of a plurality of sample historical time points, and sample location information of sample charging stations. The label may be an actual charging demand power at a first time point. The first time point is a time point after the plurality of sample historical time points, and is a future moment relative to the plurality of sample historical time points. In some embodiments, the label may be obtained by automatic or manual labeling.

In some embodiments, determining the predicted charging demand power based on the predictive model may accurately determine the predicted charging demand power of at least one preset future moment in communication with the actual situation, thereby reducing the labor cost and waste of resources required for manual evaluation and determination.

The target completion degree refers to a coverage degree or a satisfaction degree of the charging allocation strategy corresponding to the candidate charging target to the candidate charging target. In some embodiments, the target completion degree may be expressed in a text, a number, a percentage, etc. The textual representation may include “high,” “medium,” “low,” etc. The numerical representation may include “1-10,” etc. The percentage representation may include “0-100%,” etc.

The estimated total cost is an estimated value of a total electrical supply cost during the preset future time period. For example, the estimated total cost may be an estimated value of the total electrical supply cost between the current time point and at least one preset future time point.

In some embodiments, the processor 260 may evaluate the target completion degree and the estimated total cost corresponding to each candidate charging target through a plurality of approaches based on the predicted charging demand power. For example, the processor 260 may determine a first evaluation value of the target completion degree of each candidate charging target based on the predicted charging demand power through a first preset rule, and may determine a second evaluation value of the estimated total cost of each candidate charging target through a second preset rule. The first evaluation value may be positively correlated with the target completion degree of the candidate charging targets. The second evaluation value may be negatively correlated with the estimated total cost of the candidate charging targets.

In some embodiments, the processor 260 may determine the charging target through a plurality of approaches based on the target completion degree and the estimated total cost. For example, the processor 260 may determine the charging target through a third preset rule based on the first evaluation value of the target completion degree and the second evaluation value of the estimated total cost. Exemplarily, the processor 260 may calculate a statistical average value (e.g., a mean value, a median value, a weighted average value, etc.) based on the first evaluation value and the second evaluation value of each candidate charging target, rank the candidate charging targets based on the statistical average value, and determine the highest ranked candidate charging target as the charging target.

In some embodiments of the present disclosure, the processor 260 may evaluate the target completion degree and the estimated total cost corresponding to each candidate charging target based on the predicted charging demand power, and determine the final charging target based on the target completion degree and the estimated total cost, which comprehensively considers the charging demand and the charging cost, thereby providing the best charging target for the user, reducing the charging cost of the user, saving the charging time, and improving the service experience of the user.

In some embodiments, the processor 260 may determine the charging allocation strategy of the charging station during the preset future time period through a plurality of approaches based on the electrical storage feature, the electrical supply feature, the vehicle demand feature, and the charging target. For example, the processor 260 may determine the charging allocation strategy by looking up a preset table. The preset table may include a correspondence relationship between the charging target and the charging allocation strategy. The processor 260 may determine the charging allocation strategy based on a matching degree among the electrical storage feature, the electrical supply feature, the vehicle demand feature, and the charging target according to the correspondence relationship between the charging target and the charging allocation strategy. Exemplarily, the processor 260 may construct a search vector based on the electrical storage feature, the electrical supply feature, and the vehicle demand feature, construct a charging target vector based on the charging target, and determine the matching degree based on a distance between the search vector and the charging target vector. The matching degree may be negatively correlated with the distance between the search vector and the charging target vector. Further, the processor 260 may determine the charging allocation strategy corresponding to the charging target vector having the largest matching degree (i.e., the smallest distance) as the charging allocation strategy of the charging station during the preset future time period.

In some embodiments, when the charging target is the first target, the charging allocation strategy may include a first allocation strategy. The processor 260 determines the first allocation strategy. The first allocation strategy may include: in response to determining that an output power of the battery is greater than the charging demand power, controlling the battery to charge the charging vehicle. In some embodiments, the first allocation strategy further includes in response to determining that the storage capacity of the battery is less than a preset value, the processor 260 at least controls the electrical grid to charge the battery. In response to determining that the output power of the battery is less than the charging demand power, the processor 260 controls the electrical grid and the battery to charge the vehicle. In response to determining that the storage capacity of the battery is less than the preset value, the processor 260 at least controls the electrical grid to charge the battery.

In some embodiments, the processor 260 determines the first allocation strategy. The first allocation strategy may also include: in response to determining that the operating state of the charging station is the idle state, the processor 260 at least controls the electrical grid to charge the battery, until the operating state of the charging station turns to be the charging state.

A preset value of the storage capacity refers to a minimum threshold of the storage capacity of the battery for the charging station capable of providing a charging service normally. In some embodiments, the preset value of the storage capacity may be a system default value, an empirical value, etc.

In some embodiments of the present disclosure, in response to determining that taking the charging target as a priority, the charging allocation strategy may firstly meet the vehicle demand, so as to realize charging and power supplement for the charging vehicle at any time, and ensure the service efficiency and user experience.

In some embodiments, in response to determining that the charging target is the second target, the charging allocation strategy may include a second allocation strategy. More descriptions regarding the second allocation strategy may be found in FIG. 4 and its related descriptions.

In some embodiments, in response to determining that the charging target is a third target, the charging allocation strategy may include a third allocation strategy. More descriptions regarding the third allocation strategy may be found in FIG. 5 and its related descriptions.

In 350, the processor controls, based on the charging allocation strategy, at least one of the electrical grid or the battery to charge, through the charging module, a target object according to at least one charging power within the preset future time period.

In some embodiments, the target object may include the battery of the charging station and/or the charging vehicle.

In some embodiments of the present disclosure, the processor 260 may determine the charging allocation strategy during the preset future time period based on the electrical storage feature, the electrical supply feature, the vehicle demand feature, and the charging target. Further, the processor 260 may realize a charging power allocation of the electrical grid and/or the battery based on the charging allocation strategy, which can solve the problem of strong randomness of users' subjective charging willingness to a certain extent, realize the effect of reasonable allocation to electric energy according to a business demand, the electrical supply cost, and the working state of the charging station, thereby achieving an optimal interaction between the charging station and the electrical grid, and reducing the energy waste.

FIG. 4 is a flowchart illustrating an exemplary method for charging allocation of a charging station based on a second target according to some embodiments of the present disclosure. As shown in FIG. 4, a process 400 includes operations 410-430. In some embodiments, one or more operations of the process 400 shown in FIG. 4 may be implemented in a charging allocation device 200 of a charging station shown in FIG. 2. In some embodiments, the process 400 may be performed by the processor 260.

In 410, in response to determining that a charging target is a second target, a charging allocation strategy includes a second allocation strategy.

In some embodiments, determining the second charging allocation strategy includes dividing a preset future time period into at least two charging intervals 411 based on the electrical supply feature.

As described above, a charging interval refers to a sub-time period of the preset future time period. In some embodiments, the at least two charging intervals at least include a low-cost charging interval 411-1 and a high-cost charging interval 411-2. The low-cost charging interval 411-1 may be a first sub-time period corresponding to the valley period of the electrical grid. The high-cost charging interval 411-2 may be a second sub-time period corresponding to the peak period of the electrical grid. For example, the preset future time period is within a range of 0:00 to 17:00, a valley period of the electrical grid is within an interval of 0:00 to 8:00, which corresponds to the low-cost charging interval 411-1, and a peak period of the electrical grid is within an interval of 14:00 to 17:00, which corresponds to the high-cost charging interval 411-2.

In some embodiments, the low-cost charging interval 411-1 may include at least one first sub-interval. More descriptions regarding the at least one first sub-interval may be found in operation 420 and its related descriptions.

In some embodiments, the high-cost charging interval 411-2 may include at least one second sub-interval. More descriptions regarding the at least one second sub-interval may be found in operation 430 and its related descriptions.

In some embodiments, the processor 260 may divide the preset future time period into the at least two charging intervals through a plurality of approaches. For example, the processor 260 may divide the charging intervals by manually entering information. As another example, the processor 260 may divide the charging intervals based on historical data.

In some embodiments, the energy management system 210 may also divide the charging intervals by reading real-time data from the electrical grid system and sending the division results to the processor 260.

In 420, at least one first sub-interval is determined based on at least one of a storage capacity and a future electrical supply cost feature.

In some embodiments, each of the at least one first sub-interval corresponds to a set of charging processes, each set of charging processes includes the corresponding charging power allocation and a power supplementary condition.

In some embodiments, the future electrical supply cost feature may refer to a time interval between a current charging interval and a subsequent charging interval. For example, a subsequent charging interval is within an interval of 8:00 to 16:00, and for a moment 3:00 in the current charging interval 0:00 to 8:00, a time interval from the starting moment to the next charging interval 8:00 is 5 hours.

In some embodiments, at least one first sub-interval at least includes a pre-valley period and a post-valley period. For example, if a valley period of the electrical grid is within an interval of 0:00 to 8:00, a pre-valley period may be within an interval of 0:00 to 4:00 and a post-valley period may be within an interval of 4:00 to 8:00.

The charging power allocation refers to an allocation of the output power of the battery of the charging station. For example, the output power of the battery corresponding to the pre-valley period may be greater than the output power of the battery corresponding to the post-valley period.

The power supplementary condition refers to a condition that needs to be met to supplement power to the battery of the charging station through the electrical grid. In some embodiments, the power supplementary condition may at least relate to one or more of the storage capacity, the electrical supply cost, and the charging demand power. For example, when the storage capacity can not be sufficient to meet the charging demand power, the processor 260 may control the electrical grid to supplement power to the battery. As another example, when the electrical supply cost is relatively low, the processor 260 may control the electrical grid to supplement power to the battery.

In some embodiments, the power supplementary condition at least includes a first preset capacity threshold of the battery of the charging station.

In some embodiments, determining the first preset capacity threshold may include determining a first evaluation value of at least one candidate capacity threshold based on a target completion degree and an estimated total cost corresponding to the at least one candidate capacity threshold, and determining the first preset capacity threshold based on the first evaluation value.

The preset capacity threshold refers to a preset value of a storage capacity threshold. For example, the preset capacity threshold may be 50% of a total capacity.

In some embodiments, the processor 260 may determine the first preset capacity threshold through a plurality of approaches. For example, the processor 260 may determine the first preset capacity threshold from manually entered data. As another example, the processor 260 may select the first preset capacity threshold from the at least one candidate capacity threshold based on a preset condition.

The candidate capacity thresholds refer to available capacity thresholds. For example, the candidate capacity thresholds may include 30%, 50%, 70%, etc., of the total capacity.

In some embodiments, the processor 260 may determine the at least one candidate capacity threshold through a plurality of approaches based on the target completion degree and the estimated total cost. For example, the processor 260 may determine the at least one candidate capacity threshold by a random generation manner based on the target completion degree and the estimated total cost. As another example, the target completion degree and the estimated total cost may be represented by a data vector. The processor 260 may calculate a vector distance between the data vector and a historical data vector corresponding to a historical target completion degree and a historical total cost, and determine at least one historical capacity threshold corresponding to a vector distance less than a preset distance threshold as the at least one candidate capacity threshold. The preset distance threshold may refer to a minimum vector distance between the preset data vector and the historical data vector.

In some embodiments, the processor 260 may determine the first preset capacity threshold based on the target completion degree and estimated total cost corresponding to the at least one candidate capacity threshold. More descriptions regarding the target completion degree and estimated total cost may be found in FIG. 3 and its related descriptions.

In some embodiments, the processor 260 may determine the at least one first sub-interval through a plurality of approaches based on at least one of the storage capacity and the future electrical supply cost feature. For example, the processor 260 may determine the at least one first sub-interval based on a result of manual input. As another example, the processor 260 may construct a first vector based on the capacity storage and the future electrical supply cost feature, and determine a first reference vector having a similarity to the first vector greater than a preset threshold by searching a vector database. Further, the processor 260 may determine the at least one first sub-interval by statistically averaging the historical first sub-intervals corresponding to the first reference vectors.

In some embodiments, the processor 260 may determine the at least one first sub-interval based on the future electrical supply cost feature. For example, the processor 260 may determine the at least one first sub-interval based on a preset reference time point. The preset reference time point may be a preset time point within the current charging interval, wherein a time interval between the preset reference time point and a start moment of the subsequent charging interval satisfies a preset condition. Exemplarily, if 1:00 to 5:00 is a low-cost charging interval, 5:00 to 9:00 is a high-cost charging interval, and 3:00 is a preset reference time point, at this time, a time interval between 3:00 and 5:00 is 2 hours, which satisfies the preset condition, and the processor 260 may determine 1:00 to 3:00 (i.e., a pre-valley period) and 3:00 to 5:00 (i.e., a post-valley period) as first sub-intervals.

In some embodiments, the processor 260 may determine the at least one first sub-interval based on the storage capacity. For example, the processor 260 may determine the at least one first sub-interval based on the preset capacity threshold. Exemplarily, if the preset capacity threshold is 50% of the total capacity, for the low-cost charging interval, the processor 260 may determine a time period in which a storage capacity is above 50% of the total capacity (i.e., a pre-valley period) and a time period in which a storage capacity reaches and/or falls below 50% of the total capacity (i.e., a post-valley period) as the first sub-intervals.

In some embodiments, the processor 260 may determine the at least one first sub-interval based on the storage capacity and the future electrical supply cost feature. For example, if 1:00 to 5:00 is a low-cost charging interval, the processor 260 may first determine 1:00 to 3:00 as the pre-valley period based on the future electrical supply cost feature. For 3:00 to 5:00, if the storage capacity during this time period is at and/or below 50% of the total capacity, the processor 260 may determine 3:00 to 5:00 as the post-valley period. If the storage capacity during this time period is above 50% of the total capacity, the processor 260 may still determine 3:00 to 5:00 as the pre-valley period. As another example, the processor 260 may first determine 4:00 to 5:00 as the post-valley period based on the future electrical supply cost feature. For 1:00 to 4:00, if the storage capacity during that time period is at and/or below 50% of the total capacity, the processor 260 may still determine 1:00 to 4:00 as the post-valley period. If the storage capacity during that time period is above 50% of the total capacity, the processor 260 may determine 1:00 to 4:00 as the pre-valley period.

In some embodiments, each of the at least one first sub-interval may have a different charging process. For example, for the pre-valley period, in response to determining that the storage capacity is higher than the first preset capacity threshold, the processor 260 may control at least one of the battery and/or the electrical grid to charge the charging vehicle, while controlling the electrical grid to supplement power to the battery. As another example, in response to determining that the storage capacity reaches and/or falls lower than the first preset capacity threshold, the processor 260 may control the electrical grid to charge the charging vehicle while controlling the electrical grid to supplement power to the battery. As still another example, for the post-valley period, the processor 260 may control the electrical grid to charge at least one of the battery and/or the charging vehicle, thereby ensuring that the storage capacity can meet the preset condition and/or an actual demand (e.g., the storage capacity reaches 100% of the total capacity) before switching to the high-cost charging interval.

In some embodiments of the present disclosure, the processor 260 may determine the at least one first sub-interval based on the storage capacity and/or the future electrical supply cost feature, which can make a predicted usage of the storage capacity and the electrical supply cost more closely match the actual usage, thereby providing the user with a more accurate charging allocation strategy, enhancing the user experience, and avoiding the energy waste.

In 430, at least one second sub-interval is determined based on at least one of the storage capacity and the future electrical supply cost feature.

In some embodiments, each of the at least one second sub-interval corresponds to a set of charging processes, each set of charging processes includes the corresponding charging power allocation and a corresponding power supplementary condition.

In some embodiments, the at least one second sub-interval may at least include a pre-peak period and a post-peak period. For example, if the peak period of the electrical grid is within an interval of 14:00 to 17:00, the pre-peak period may be within an interval of 14:00 to 16:00 and the post-peak period may be within an interval of 16:00 to 17:00.

In some embodiments, the at least one second sub-interval may also be a high-cost charging interval. More descriptions regarding the high-cost charging interval, the charging power allocation, and the power supplementary condition may be found in operation 420 and its associated descriptions.

In some embodiments, the processor 260 may determine the at least one second sub-interval based on at least one of the storage capacity and the future electrical supply cost feature. The determination of the at least one second sub-interval is similar to the determination of the at least one first sub-interval. Specific descriptions may be found in operation 420 and its related descriptions.

In some embodiments, in response to determining that the at least one second sub-interval is the high-cost charging interval, the processor 260 may adopt different charging allocation strategies based on the first preset capacity threshold. For example, in response to determining that the storage capacity is higher than the first preset capacity threshold, the processor 260 may control the battery to charge the charging vehicle. As another example, in response to determining that the storage capacity reaches the first preset capacity threshold, the processor 260 may control at least one of the battery and/or the electrical grid to charge the charging vehicle.

In some embodiments, each of the at least one second sub-interval may have a different charging process. For example, for the pre-peak period, the processor 260 may control the battery to charge the charging vehicle. When the storage capacity is too low (e.g., the storage capacity does not meet the charging demand power or does not provide a normal charging service), the processor 260 may control the electrical grid to properly supplement power to the battery. When the storage capacity is 0, the processor 260 may control the electrical grid to charge the charging vehicle through an ACDC module. As another example, for the post-peak period, the battery is not allowed to be recharged through the electrical grid, and only when the storage capacity is 0, the processor 260 is allowed to control the electrical grid to charge the charging vehicle through the ACDC module.

In some embodiments of the present disclosure, when the charging target is the second target, the processor 260 may divide the preset future time period into the low-cost charging interval and the high-cost charging interval based on the electrical supply feature. The processor 260 may control the electrical grid to charge the at least one of the battery and/or the charging vehicle during a time period when the electricity price is relatively low, and control the battery to participate in charging the charging vehicle during a time period when the electricity price is relatively high, thereby achieving the effective reduction of the charging cost for the user and the improvement of charging service reliability under a condition of ensuring that the storage capacity of the battery of the charging station meets the usage demand.

FIG. 5 is a flowchart illustrating an exemplary method for charging allocation of a charging station based on a third target according to some embodiments of the present disclosure. As shown in FIG. 5, a process 500 includes operations 510-540. In some embodiments, one or more of the operations of the process 500 shown in FIG. 5 may be implemented in the charging allocation device 200 of the charging station shown in FIG. 2. In some embodiments, the process 500 may be performed by the processor 260.

In 510, when the charging target is a third target, the charging allocation strategy includes a third allocation strategy.

In some embodiments, determining the third allocation strategy includes dividing the preset future time period into at least three charging intervals 511 based on the electrical supply feature. In some embodiments, the at least three charging intervals at least include a low-cost charging interval 511-1, a high-cost charging interval 511-2, and a mid-cost charging interval 511-3. More descriptions regarding the low-cost charging interval and the high-cost charging interval may be found in FIG. 4 and its related descriptions.

In some embodiments, the mid-cost charging interval 511-3 may be a third sub-time period corresponding to a flat period of the electrical grid. For example, the preset future time period is within an interval of 0:00 to 17:00, and the flat period of the electrical grid is within an interval of 8:00 to 14:00, which corresponds to a mid-cost charging interval.

In some embodiments, the mid-cost charging interval 511-3 includes at least one third sub-interval. More descriptions regarding the at least one third sub-interval may be found in operation 540 and its related descriptions.

In 520, at least one first sub-interval is determined based on at least one of a storage capacity and a future electrical supply cost feature. Specific descriptions regarding the at least one first sub-interval may be found in FIG. 4 and its related descriptions.

In 530, at least one second sub-interval is determined based on at least one of the storage capacity and the future electrical supply cost feature. Specific descriptions regarding the at least one second sub-interval may be found in FIG. 4 and its related descriptions.

In 540, at least one third sub-interval is determined based on at least one of the storage capacity and the future electrical supply cost feature.

In some embodiments, each of the at least one third sub-interval has a different charging power allocation and power supplementary condition.

In some embodiments, the at least one third sub-interval may at least include a pre-flat period and a post-flat period. For example, if a flat period of the electrical grid is within an interval of 8:00 to 14:00, the pre-flat period may be within an interval of 8:00 to 11:00, and the post-flat period may be within an interval of 11:00 to 14:00.

More descriptions regarding the future electrical supply cost feature and the charging power allocation may be found in FIG. 4 and its related descriptions.

In some embodiments, the power supplementary condition at least includes a second preset capacity threshold. Determining the second preset capacity threshold may include determining a second evaluation value corresponding to at least one candidate capacity threshold based on a target completion degree and an estimated total cost corresponding to the at least one candidate capacity threshold, and determining the second preset capacity threshold based on the second evaluation value. A process for determining the second preset capacity threshold is similar to a process for determining the first preset capacity threshold, more descriptions may be found in FIG. 4 and its related descriptions.

In some embodiments, the second preset capacity threshold may include a preset storage capacity threshold that is required to charge the charging station. For example, the second preset capacity threshold may be 30 kWh.

In some embodiments, the processor 260 may determine the second preset capacity threshold through a plurality of approaches. For example, the processor 260 may determine the second preset capacity threshold through manually entered data. As another example, the processor 260 may select the second preset capacity threshold from at least one candidate storage capacity threshold based on a preset condition.

The candidate storage capacity thresholds refer to available storage capacity thresholds. For example, the candidate storage capacities may include 20 kWh, 30 kWh, 40 kWh, etc. In some embodiments, a candidate storage capacity threshold may also be referred to as a candidate capacity threshold.

In some embodiments, the processor 260 may determine the at least one candidate storage capacity threshold through a plurality of approaches based on the target completion degree and the estimated total cost. For example, the processor 260 may determine at least one candidate storage capacity by a random generation manner based on the target completion degree and the estimated total cost. As another example, the target completion degree and the estimated total cost may be represented by a data vector. The processor 260 may calculate a vector distance between the data vector and a historical data vector corresponding to the historical target completion degree and the historical total cost, and determine at least one historical storage capacity corresponding to a vector distance less than a preset distance threshold as the at least one candidate storage capacity. The preset distance threshold may refer to a minimum vector distance between the preset data vector and the historical data vector.

In some embodiments, the processor 260 may determine the second preset capacity threshold based on the target completion degree and the estimated total cost corresponding to the at least one candidate storage capacity. More descriptions regarding the target completion degree and the estimated total cost may be found in FIG. 3 and its related descriptions.

In some embodiments, the processor 260 may determine the at least one third sub-interval based on at least one of the storage capacity and the future electrical supply cost feature. The determination of the at least one third sub-interval is similar to the determination of the at least one first sub-interval, specific descriptions may be found in FIG. 4 and its related descriptions.

In some embodiments, each of the at least one third sub-interval may have a different charging process. For example, for the pre-flat period, in response to determining that the storage capacity is higher than the second preset capacity threshold, the processor 260 may control at least one of the battery and/or the electrical grid to charge the charging vehicle. In response to determining that the storage capacity is at and/or is lower than the second preset capacity threshold, the processor 260 may control the electrical grid to charge at least one of the charging vehicle and/or the battery. As another example, for the post-flat period, the processor 260 may control the electrical grid to charge at least one of the charging vehicle and/or the battery and allow to control the electrical grid to supplement power to the storage capacity of the battery to meet the preset condition and/or the actual demand (e.g., the storage capacity reaches 70% of the total capacity).

In some embodiments of the present disclosure, when the charging target is the third target, the processor 260 may divide the preset future time period into the low-cost charging interval, the mid-cost charging interval, and the high-cost charging interval based on the electrical supply feature. The processor 260 may adopt the electrical grid recharge strategy more flexibly based on the actual demand, thereby effectively decreasing the charging cost of the user and reducing the energy waste under the condition of ensuring that the storage capacity of the battery of the charging station meets the usage demand.

One or more embodiments of the present disclosure provide a system for charging allocation of the charging station, the system at least includes a first obtaining module, a second obtaining module, a third obtaining module, a determination module, and a control module.

In some embodiments, the first obtaining module is configured to determine an electrical storage feature based on first sensing information. The first sensing information is collected by a first sensor based on a battery of the charging station, and the electrical storage feature at least includes a storage capacity of the battery.

In some embodiments, the second obtaining module is configured to determine an electrical supply feature based on second sensing information. The second sensing information is collected by a second sensor based on an electrical grid, and the electrical supply feature at least includes an electrical supply cost of the electrical grid.

In some embodiments, the third obtaining module is configured to determine a vehicle demand feature based on third sensing information. The third sensing information is collected by a third sensor based on a charging vehicle, and the vehicle demand feature at least includes a charging demand power of the charging vehicle.

In some embodiments, the determination module is configured to determine a charging allocation strategy of the charging station during a preset future time period based on the electrical storage feature, the electrical supply feature, the vehicle demand feature, and a charging target.

In some embodiments, the control module is configured to control, based on the charging allocation strategy, at least one of the electrical grid or the battery to charge, through a charging module, a target object according to at least one charging power within the preset future time period.

More descriptions regarding various modules of the system for charging allocation of the charging station and their functions may be found in FIG. 3-FIG. 5 of the present disclosure and their related descriptions.

One or more embodiments of the present disclosure further provide a non-transitory computer-readable storage medium. The non-transitory computer-readable storage medium stores computer instruction. When a computer reads the computer instruction in the storage medium, the computer executes the method for charging allocation of the charging station of any one of the above embodiments.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations thereof, are not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the count of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Therefore, by way of example, but not of limitation, alternative configurations of the embodiments of the application may be utilized in accordance with the teachings herein. Accordingly, embodiments of the present application are not limited to that precisely as shown and described.

1. A charging allocation device of a charging station, comprising a first sensor, a second sensor, a third sensor, a charging module, and a processor, wherein
the processor is in communication with the first sensor, the second sensor, the third sensor, and the charging module;
the processor is configured to:
determine an electrical storage feature based on first sensing information, wherein the first sensing information is collected by the first sensor based on a battery of the charging station, and the electrical storage feature at least includes a storage capacity of the battery;
determine an electrical supply feature based on second sensing information, wherein the second sensing information is collected by the second sensor based on an electrical grid, and the electrical supply feature at least includes an electrical supply cost of the electrical grid;
determine a vehicle demand feature based on third sensing information, wherein the third sensing information is collected by the third sensor based on a charging vehicle, and the vehicle demand feature at least includes a charging demand power of the charging vehicle;
determine a charging allocation strategy of the charging station during a preset future time period based on the electrical storage feature, the electrical supply feature, the vehicle demand feature, and a charging target; and
control, based on the charging allocation strategy, at least one of the electrical grid or the battery to charge, through the charging module, a target object according to at least one charging power within the preset future time period.

2. The charging allocation device of claim 1, wherein to determine the charging allocation strategy of the charging station during the preset future time period based on the electrical storage feature, the electrical supply feature, the vehicle demand feature, and the charging target, the processor is further configured to:
determine a first allocation strategy when the charging target is a first target, the charging allocation strategy including the first allocation strategy, the first allocation strategy is determined by:
in response to determining that an output power of the battery is greater than the charging demand power, controlling the battery to charge the charging vehicle, and in response to determining that the storage capacity is less than a preset value, at least controlling the electrical grid to charge the battery; and
in response to determining that the output power of the battery is less than the charging demand power, controlling the electrical grid and the battery to charge the charging vehicle, and in response to determining that the storage capacity is less than the preset value, at least controlling the electrical grid to charge the battery.

3. The charging allocation device of claim 1, wherein to determine the charging allocation strategy of the charging station during the preset future time period based on the electrical storage feature, the electrical supply feature, the vehicle demand feature, and the charging target, the processor is further configured to:
determine a second allocation strategy when the charging target is a second target, the charging allocation strategy including the second allocation strategy, the second allocation strategy is determined by:
dividing the preset future time period into at least two charging intervals based on the electrical supply feature, wherein the at least two charging intervals at least include a low-cost charging interval and a high-cost charging interval.

4. The charging allocation device of claim 3, wherein the electrical supply feature further includes a future electrical supply cost feature, the low-cost charging interval includes at least one first sub-interval, and the processor is further configured to:
determine the at least one first sub-interval based on at least one of the storage capacity and the future electrical supply cost feature, wherein each first sub-interval of the at least one first sub-interval corresponds to one set of charging processes, respectively.

5. The charging allocation device of claim 3, wherein the electrical supply feature further includes a future electrical supply cost feature, the high-cost charging interval includes at least one second sub-interval, the processor is further configured to:
determine the at least one second sub-interval based on at least one of the storage capacity and the future electrical supply cost feature, wherein each second sub-interval of the at least one second sub-interval corresponds to one set of charging processes, respectively.

6. The charging allocation device of claim 5, wherein the one set of charging processes at least includes a corresponding power supplementary condition, the power supplementary condition at least includes a first preset capacity threshold of the battery, and the processor is further configured to:
determine a first evaluation value corresponding to at least one candidate capacity threshold based on a target completion degree and an estimated total cost corresponding to the at least one candidate capacity threshold, wherein the at least one candidate capacity threshold is determined based on historical operating data of the charging station; and
determine the first preset capacity threshold based on the first evaluation value.

7. The charging allocation device of claim 1, wherein to determine the charging allocation strategy of the charging station during the preset future time period based on the electrical storage feature, the electrical supply feature, the vehicle demand feature, and the charging target, the processor is further configured to:
determine a third allocation strategy in response to determining that the charging target is a third target, the charging allocation strategy including the third allocation strategy, the third allocation strategy is determined by:
dividing the preset future time period into at least three charging intervals based on the electrical supply feature, wherein the at least three charging intervals at least include a low-cost charging interval, a mid-cost charging interval, and a high-cost charging interval.

8. The charging allocation device of claim 7, wherein the electrical supply feature further includes a future electrical supply cost feature, the mid-cost charging interval includes at least one third sub-interval, the processor is further configured to:
determine the at least one third sub-interval based on at least one of the storage capacity and the future electrical supply cost feature, wherein each third sub-interval of the at least one third sub-interval corresponds to one set of charging processes, respectively.

9. The charging allocation device of claim 8, wherein the one set of charging processes at least includes a corresponding power supplementary condition, the power supplementary condition at least includes a second preset capacity threshold, and the processor is further configured to:
determine a second evaluation value corresponding to at least one candidate capacity threshold based on a target completion degree and an estimated total cost corresponding to the at least one candidate capacity threshold, wherein the at least one candidate capacity threshold is determined based on historical operating data of the charging station; and
determine the second preset capacity threshold based on the second evaluation value.

10. The charging allocation device of claim 1, wherein the processor is further configured to:
determine a predicted charging demand power during the preset future time period;
determine a target completion degree and an estimated total cost corresponding to each candidate charging target based on the predicted charging demand power, wherein the target completion degree refers to a degree of coverage of the charging allocation strategy corresponding to a certain candidate charging target to the candidate charging target; and
determine the charging target based on the target completion degree and the estimated total cost.

11. The charging allocation device of claim 10, wherein the processor is further configured to:
determine the predicted charging demand power through a prediction model based on historical charging demand powers of vehicles at a plurality of historical time points, historical vehicle queuing information of the vehicles at the plurality of historical time points, and location information of the current charging station, wherein the prediction model is a machine learning model.

12. A method for charging allocation of a charging station, wherein the method is implemented on a computing device having at least one storage device and at least one processor, the method comprises:
determining an electrical storage feature based on first sensing information, wherein the first sensing information is collected by a first sensor based on a battery of the charging station, and the electrical storage feature at least includes a storage capacity of the battery;
determining an electrical supply feature based on second sensing information, wherein the second sensing information is collected by a second sensor based on an electrical grid, and the electrical supply feature at least includes an electrical supply cost of the electrical grid;
determining a vehicle demand feature based on third sensing information, wherein the third sensing information is collected by a third sensor based on a charging vehicle, and the vehicle demand feature at least includes a charging demand power of the charging vehicle;
determining a charging allocation strategy of the charging station during a preset future time period based on the electrical storage feature, the electrical supply feature, the vehicle demand feature, and a charging target; and
controlling, based on the charging allocation strategy, at least one of the electrical grid or the battery to charge, through a charging module, a target object according to at least one charging power within the preset future time period.

13. The method of claim 12, wherein the determining the charging allocation strategy during the preset future time period based on the electrical storage feature, the electrical supply feature, the vehicle demand feature, and the charging target includes:
determining a first allocation strategy when the charging target is a first target, the charging allocation strategy including the first allocation strategy, the first allocation strategy is determined by:
in response to determining that an output power of the battery is greater than the charging demand power, controlling the battery to charge the charging vehicle, and in response to determining that the storage capacity is less than a preset value, at least controlling the electrical grid to charge the battery; and
in response to determining that the output power of the battery is less than the charging demand power, controlling the electrical grid and the battery to charge the charging vehicle, and in response to determining that the storage capacity is less than the preset value, at least controlling the electrical grid to charge the battery.

14. The method of claim 12, wherein the determining the charging allocation strategy during the preset future time period based on the electrical storage feature, the electrical supply feature, the vehicle demand feature, and the charging target includes:
determining a second allocation strategy when the charging target is a second target, the charging allocation strategy including the second allocation strategy, the second allocation strategy is determined by:
dividing the preset future time period into at least two charging intervals based on the electrical supply feature, wherein the at least two charging intervals at least include a low-cost charging interval and a high-cost charging interval.

15. The method of claim 14, wherein the electrical supply feature further includes a future electrical supply cost feature, the low-cost charging interval includes at least one first sub-interval, and the at least one first sub-interval is determined by:
determining the at least one first sub-interval based on at least one of the storage capacity and the future electrical supply cost feature, wherein each first sub-interval of the at least one first sub-interval corresponds to one set of charging processes, respectively.

16. The method of claim 14, wherein the electrical supply feature further includes a future electrical supply cost feature, the high-cost charging interval includes at least one second sub-interval, and determining the at least one second sub-interval includes:
determining the at least one second sub-interval based on at least one of the storage capacity and the future electrical supply cost feature, wherein each second sub-interval of the at least one second sub-interval corresponds to one set of charging processes, respectively.

17. The method of claim 14, wherein the second allocation strategy at least includes a power supplementary condition, the power supplementary condition at least includes a first preset capacity threshold of the battery, and the first preset capacity threshold is determined by:
determining a first evaluation value corresponding to at least one candidate capacity threshold based on a target completion degree and an estimated total cost corresponding to the at least one candidate capacity threshold; and
determining the first preset capacity threshold based on the first evaluation value.

18. The method of claim 12, wherein the determining the charging allocation strategy during the preset future time period based on the electrical storage feature, the electrical supply feature, the vehicle demand feature, and the charging target includes:
determining a third allocation strategy when the charging target is a third target, the charging allocation strategy including the third allocation strategy, the third allocation strategy is determined by:
dividing the preset future time period into at least three charging intervals based on the electrical supply feature, wherein the at least three charging intervals at least include a low-cost charging interval, a mid-cost charging interval and a high-cost charging interval.

19. The method of claim 18, wherein the electrical supply feature further includes a future electrical supply cost feature, the mid-cost charging interval includes at least one third sub-interval, and determining the at least one third sub-interval includes:
determining at least one third sub-interval based on at least one of the storage capacity and the future electrical supply cost feature, wherein each third sub-interval of the at least one third sub-interval corresponds to one set of charging processes, respectively.

20-23. (canceled)

24. A non-transitory computer-readable storage medium, comprising a set of instructions, wherein when executed by a computing device, the set of instructions causes the computing device to perform a method for charging allocation of a charging station, wherein the method comprises:
determining an electrical storage feature based on first sensing information, wherein the first sensing information is collected by a first sensor based on a battery of the charging station, and the electrical storage feature at least includes a storage capacity of the battery:
determining an electrical supply feature based on second sensing information, wherein the second sensing information is collected by a second sensor based on an electrical grid, and the electrical supply feature at least includes an electrical supply cost of the electrical grid;
determining a vehicle demand feature based on third sensing information, wherein the third sensing information is collected by a third sensor based on a charging vehicle, and the vehicle demand feature at least includes a charging demand power of the charging vehicle;
determining a charging allocation strategy of the charging station during a preset future time period based on the electrical storage feature, the electrical supply feature, the vehicle demand feature, and a charging target; and
controlling, based on the charging allocation strategy, at least one of the electrical grid or the battery to charge, through a charging module, a target object according to at least one charging power within the preset future time period.
